(19) United States
(12) Patent Application Publication
(10) Pub. No.: US 2016/0275074 A1
(43) Pub. Date: Sep. 22, 2016

(54) ANAPHORA RESOLUTION BASED ON LINGUISTIC TECHNOLOGIES

(71) Applicant: ABBYY InfoPoisk LLC, Moscow (RU)

(72) Inventors: Aleksey Bogdanov, Moscow (RU); Anatoly Starostin, Moscow (RU); Stanislav Dzhumaev, Khabarovsk (RU); Daniil Skorinkin, Moscow (RU)

(21) Appl. No.: 14/742,096

(22) Filed: Jun. 17, 2015

(30) Foreign Application Priority Data
Mar. 19, 2015 (RU) 2015109667

(51) Int. Cl. G06F 17/27; G06F 17/28

(52) U.S. Cl. CPC G06F 17/2785; G06F 17/28

(57) ABSTRACT

Disclosed are system, method and computer program product for creating syntactic-semantic structures of natural language sentences in natural language processing of a natural language text, comprising generating syntactic trees for each sentence including syntactic nodes and tree-like syntactic relations; generating semantic structure corresponding to the at least one syntactic tree; the at least one semantic structure includes semantic nodes corresponding to the plurality of syntactic nodes and tree-like semantic relations corresponding to the p tree-like syntactic relations; if a syntactic tree includes two different syntactic nodes corresponding to a single entity, connecting the semantic nodes corresponding to the syntactic nodes by a non-tree link.

### CROSS REFERENCE TO RELATED APPLICATIONS

This application claims the benefit of priority to Russian Patent Application No. 2015109667, filed Mar. 19, 2015; disclosure of which is hereby incorporated by reference in its entirety.

### FIELD OF TECHNOLOGY

The disclosure pertains to systems and methods of creating technologies, systems and products for automatic processing of text information (Natural Language Processing, NLP), and extracting information from texts in natural languages. Vital elements of such technologies, including methods and the applications created on the basis thereof, are systems for analysis of texts in natural language, linguistic descriptions, systems of extraction of information and ontologies as models of subject fields. Thanks to the Internet, large volumes of information presented in electronic form are becoming accessible. This information is generally unstructured, and therefore the task of automatic extraction and structuring of the available information is urgent, including the full diversity of objects and entities of the modern world and the relations among them, the formalization and identification of entities and the establishing of the relations among them for subsequent use in the construction of formal models of subject fields in various applications.

### BACKGROUND

The volume of unstructured information presented in electronic form is steadily on the rise at present. This information may contain text and other data (such as numbers, dates, etc.). In particular, a large volume of unstructured information is becoming easily accessible thanks to the Internet. At the same time, there are no universal methods of processing and structuring the information, and extracting facts and knowledge, which make it possible to do so effectively and in an acceptable time frame without human involvement. The interpretation of this information is complicated by the ambiguity which is characteristic of natural language and the variability of the methods of expression. A distinguishing feature of any natural language is the possibility of expressing the very same thought, of describing the very same fact or event, by many different methods, requiring a nontrivial approach to the syntactic analysis and the existence of exhaustive linguistic descriptions. Therefore, the task of constructing such linguistic descriptions and the methods for their use to enable a processing of a variety of linguistic phenomena, including anaphoric and co-referential relations, the comparing and identification of the same entities, facts, events, actions, etc., remains urgent.

The present disclosure describes creation of a program system to handle such tasks as the extraction of information from texts in natural language, searching for information in document collections, information monitoring, and others. The present disclosure refers to the semantic descriptions and analysis methods as described in the US Patent Application Publication US 2012/0109640 incorporated herein by reference in its entirety, the US Patent Application Publication US 2008/0091405 incorporated herein by reference in its entirety, and the U.S. Pat. No. 8,078,450 incorporated herein by reference in its entirety.

### SUMMARY

One aspect pertains to a method of processing of natural language with the purpose of subsequent use in information search systems and machine translation systems for the classification of texts and other applications connected with information in natural language. The primary feature of the present disclosure is the fact that the results of a full semantic-syntactic analysis of the input text are used for the information extraction.

The method of the present disclosure includes the use of a technology of deep text analysis, applicable to any natural language, based on a universal semantic hierarchy and language-specific descriptions of the natural language. The method includes the following stages. The existing texts are subjected to a complete syntactic and semantic parsing. Semantic structures are constructed, containing semantic classes and deep relationships. Non-tree relations are established on the resulting semantic structures, reflecting complex linguistic phenomena such as anaphora, co-referencing, etc. This, in particular, makes it possible to identify objects presented in the text in various ways, and to optionally extract additional information about the search objects. The establishing of non-tree relations is the result of applying all models which are possible for the given text and establishing all potentially possible non-tree relations with subsequent filtering and selection of the best variants.

In one aspect, an example method for creating syntactic-semantic structures of natural language sentences in natural language processing of a natural language text, comprises generating by a hardware processor at least one syntactic tree for each sentence including a plurality of syntactic nodes and a plurality of tree-like syntactic relations; generating by a hardware processor at least one semantic structure corresponding to the at least one syntactic tree, wherein the at least one semantic structure includes a plurality of semantic nodes corresponding to the plurality of syntactic nodes and a plurality of tree-like semantic relations corresponding to the plurality of tree-like syntactic relations; if the at least one syntactic tree includes at least two different syntactic nodes corresponding to a single entity, then connecting the semantic nodes corresponding to the at least two different syntactic nodes by at least one non-tree link; and performing by the hardware processor further natural language processing of the text using the semantic structure.

Another aspect pertains to the system. This system includes one or more computing devices. This system also includes one or more memory devices, in which the commands are stored which, when executed on the one or more computing devices, result in these computing devices carrying out the following operations: full syntactic and semantic parsing of the available text corpuses, construction of semantic structures containing semantic classes and deep relationships, for sentences from the texts forming these corpuses.

In another aspect, an example system for creating syntactic-semantic structures of natural language sentences in natural language processing of a natural language text comprises a syntactic analysis module configured to generate at least one syntactic tree for each sentence including a plurality of syntactic nodes and a plurality of tree-like syntactic relations; a semantic analysis module configured: to generate at least one semantic structure corresponding to the at least one syntactic tree, wherein the at least one semantic structure includes a plurality of semantic nodes corresponding to the plurality of syntactic nodes and a plurality of tree-like semantic relations corresponding to the plurality of tree-like syntactic relations; to determine if the at least one syntactic tree includes at least two different syntactic nodes corresponding to a single entity, and then to connect the semantic nodes corresponding to the at least two different syntactic nodes by at least one non-tree link; and a natural language processing module for further natural language processing of the text using the semantic structure.

Yet another aspect pertains to a machine-readable data storage medium containing machine commands wherein, when said commands are executed by the computing device, this computing device carries out the following operations: full syntactic and semantic parsing of the available text corpuses, construction of semantic structures containing semantic classes and deep relationships, for sentences from the texts forming these corpuses.

In yet another aspect, an example computer program product stored on a non-transitory computer-readable storage medium, the computer program product comprising computer-executable instructions for creating syntactic-semantic structures of natural language sentences in natural language processing of a natural language text, comprises instructions for generating by a hardware processor at least one syntactic tree for each sentence including a plurality of syntactic nodes and a plurality of tree-like syntactic relations; generating by a hardware processor at least one semantic structure corresponding to the at least one syntactic tree, wherein the at least one semantic structure includes a plurality of semantic nodes corresponding to the plurality of syntactic nodes and a plurality of tree-like semantic relations corresponding to the plurality of tree-like syntactic relations; if the at least one syntactic tree includes at least two different syntactic nodes corresponding to a single entity, then connecting the semantic nodes corresponding to the at least two different syntactic nodes by at least one non-tree link; and performing by the hardware processor further natural language processing of the text using the semantic structure.

In some aspects, the connecting of the semantic nodes by the at least one non-tree link comprises generating a plurality of possible non-tree links between the syntactic nodes; calculating a rank for each possible non-tree link; and selecting the possible non-tree links with the highest ranking. In some aspects, the calculating a rank for each possible non-tree link uses similarity metric for entities in a semantic hierarchy corresponding to the semantic nodes of the semantic structures. In some aspects, the at least two different syntactic nodes belong to at least two different syntactic trees. In some aspects, the at least two different syntactic nodes include a controller node and a pronoun node controlled by the controller node; wherein the determining that the controller node and the pronoun node correspond to a single entity includes accessing an anaphora rule.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and particularly pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates the method of an example aspect;

FIG. 2 shows a block diagram of a method of producing a set of syntactic trees from documents and from other sources in accordance with one or more aspects;

FIG. 2A shows an example of the lexical-morphological structure of a sentence in accordance with one or more aspects;

FIG. 2B shows a diagram illustrating the lexical descriptions used in accordance with one possible aspects;

FIG. 3 shows a diagram illustrating the morphological descriptions in accordance with one or more aspects;

FIG. 4 shows a diagram illustrating the syntactic descriptions in accordance with one or more aspects;

FIG. 5 shows a diagram illustrating the semantic descriptions in accordance with one or more aspects;

FIG. 6 shows a diagram illustrating the lexical descriptions in accordance with one or more aspects;

FIG. 7 illustrates the sequence of data structures which are constructed in the analysis process in accordance with one or more aspects;

FIG. 8 shows a schematic example of a graph of generalized constituents for the aforementioned sentence “This boy is smart, he'll succeed in life” in accordance with one or more aspects;

FIG. 9 shows an example of the syntactic structure of the English sentence “This boy is smart, he'll succeed in life” in accordance with one or more aspects;

FIG. 9A shows an example of the syntactic structure with established non-tree relations.

FIG. 10 illustrates the semantic structure of the English sentence “This boy is smart, he'll succeed in life” in accordance with one or more aspects;

FIG. 11 illustrates the syntactic tree of the sentence without non-tree relations in accordance with one possible aspect.

FIG. 11A illustrates the syntactic structure of the sentence with non-tree relations established in accordance with a possible aspect.

FIG. 12 illustrates the syntactic tree of the sentence without non-tree relations in accordance with one possible aspect.

FIG. 12A illustrates the syntactic structure of the sentence with non-tree relations established in accordance with one possible aspect.

FIG. 12B illustrates the syntactic structure of the sentence with non-tree relations established in accordance with one possible aspect.

FIG. 12C illustrates the syntactic structure of the sentence in accordance with one possible aspect.

FIG. 13 illustrates an example of establishing non-tree relations on the set of sentences.

FIG. 13A illustrates a fragment of a semantic hierarchy.

FIG. 13B illustrates another fragment of a semantic hierarchy.

FIG. 13C illustrates yet another fragment of a semantic hierarchy.

FIG. 14 shows the computing devices for the creation of a computer system in accordance with one possible aspect.

The following detailed specification makes references to the accompanying drawings. The same symbols in the drawings refer to the same components, unless otherwise indicated. The sample aspects presented in the detailed specification, the drawings and the patent claims are not the only ones possible. The example aspects can be used or modified by other methods not described below, without abridging their scope or their essence. The different variants presented in the specification of the example aspects and illustrated by the drawings can be arranged, replaced and grouped in a broad selection of different configurations, which are examined in detail in the present specification.

### DETAILED DESCRIPTION

Example aspects are described herein in the context of a system and method for anaphora resolution based on linguistic technologies. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like slots.

The specified method and system are based on a universal approach to text analysis, which includes a technology making use of language descriptions in universal terms not depending on a particular language (the core), and a lexical content which includes the lexicon of the particular language and linguistic models of the word formation and inflection, as well as syntactic models of word usage and agreement in this language.

This universal core, independent of the particular language, and known as a semantic hierarchy, contains a broad set of knowledge about the world and the methods of expressing this knowledge in natural languages. This knowledge can be presented in the form of a hierarchical description of the entities existing in the world, their properties, possible attributes, their interrelationships and the methods of expressing this knowledge in a particular language. Semantic description of this type is useful for creating technologies of automatic processing of natural language, especially applications which are able to “understand the meaning” expressed in a natural language; these are needed to create applications and to solve numerous problems in natural language processing, such as machine translation, semantic indexing and semantic searching, including multilingual semantic searching, extraction of facts, analysis of tonality, searching for similar documents, classification of documents, generalization, analysis of large volumes of data, electronic detection, morphological and lexical analyzers, and other applications.

In particular, the systems and methods disclosed herein make it possible to create natural language processing systems, extract information from texts, store and process text units (words, sentences, and texts) and perform the same operations with lexical and semantic values of words, sentences, texts, and other units of information.

The present disclosure describes a method and system of processing of linguistic phenomena generating non-tree relations in sentences. The sentences are subjected to a deep semantic-syntactic analysis. At least one semantic-syntactic tree is constructed for each sentence of the input text. In the course of the analysis, non-tree relations may appear in these trees, which arise if the corresponding sentence has such linguistic phenomena as ellipsis, anaphora, co-reference, etc. The resulting structures are known as semantic structures or semantic-syntactic trees. These structures are generated by a parser performing text analysis in accordance with the method specified in the U.S. Pat. No. 8,078,450. Each tree forming the foundation of the semantic structure is projective; the nodes correspond to the words of the input text, but zero nodes are also allowed (not having a surface expression). The nodes are matched up with universal entities—the nodes of a semantic hierarchy, known as semantic classes; the arms of the tree are labeled by deep slots.

Let us explain the problem of establishing non-tree relations by examples. We shall consider the sentence “The boy gave the girl his apple”. In this sentence, there is an obvious relation between the words “boy” and “his”, indicating that the boy gave precisely his apple, and not some other apple, such as one lying on a plate or plucked from a tree. This relation can and should be established, but this requires certain nontrivial actions. For this, the syntactic model should contain a corresponding description and there needs to be identified in the sentence being analyzed the semantic role (Possessor), which is played by the word in the sentence, in the present case a possessive pronoun. However, there are different types of such non-tree relations and the determination of the semantic role; and, accordingly, the selection of the deep slot is not always unambiguous. In the sentence “the boy knows his enemy”, the lexeme “his” plays a different semantic role, that of Object. If different variants of establishing non-tree relations are possible, and different variants for selection of semantic roles, then all possible cases will be considered, each variant will be assessed, and the most relevant one will be chosen.

The following types of anaphoric relations will be considered.

Pronominal Anaphora.

A pronominal anaphora is a phenomenon expressed in text by the pronouns: he, she, it, they, I, we, you, (my/your/him/her/it)self, one's, one another, such, and certain others.

Relative Anaphora

Another type of anaphora which is to be analyzed and resolved is found in sentences containing a noun phrase and a relative pronoun, such as, “The boy who arrived”.

Co-reference is an attempt to associate two or more different nouns or noun phrases which refer to the same entity. The problem is complicated if the noun phrases do not have intersecting text, such as Obama and the President of the USA (a relatively simple instance is Obama and Barack Obama). This problem correlates with the problem of identification of named entities and extraction of facts from texts.

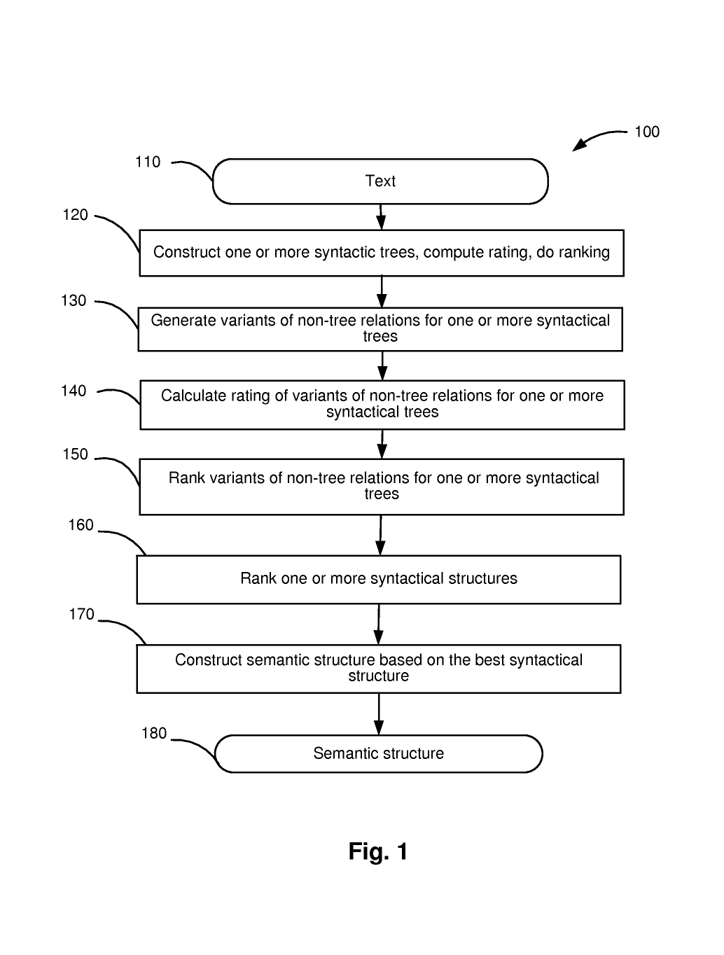

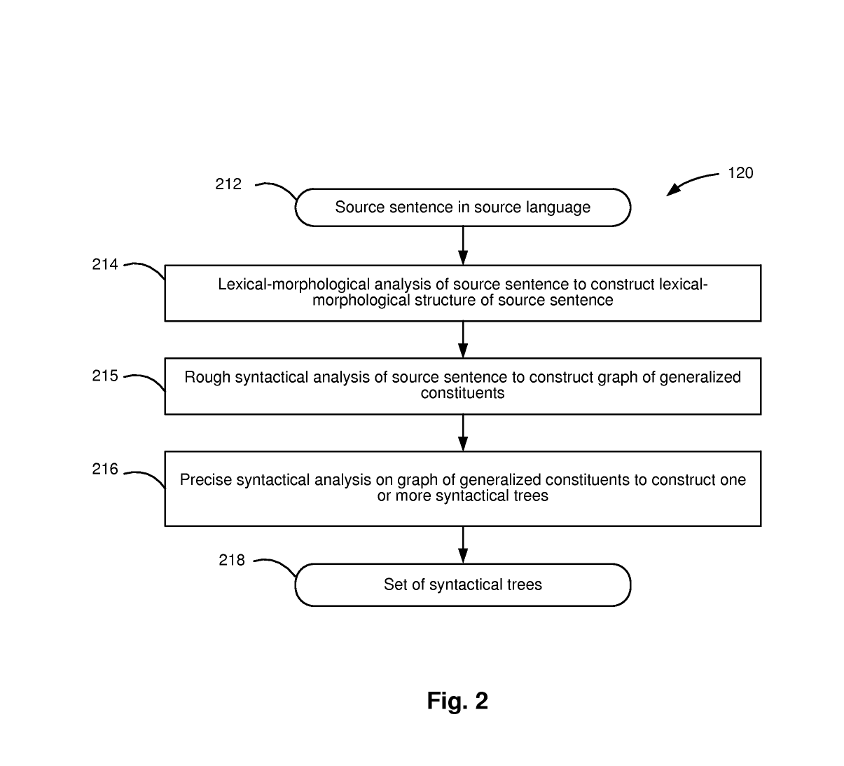

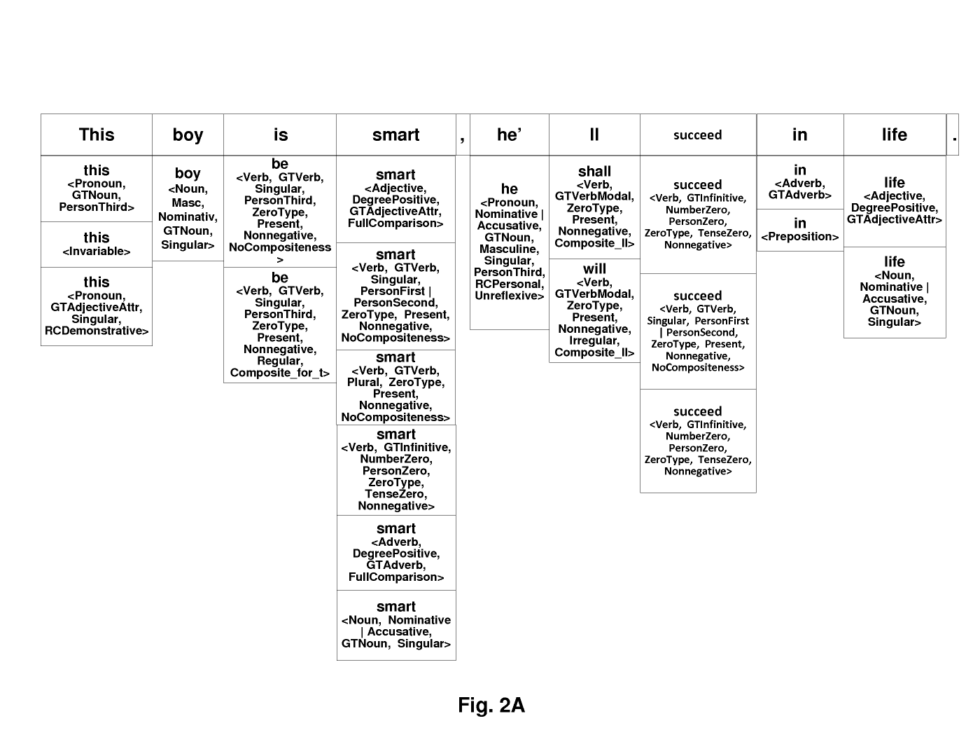

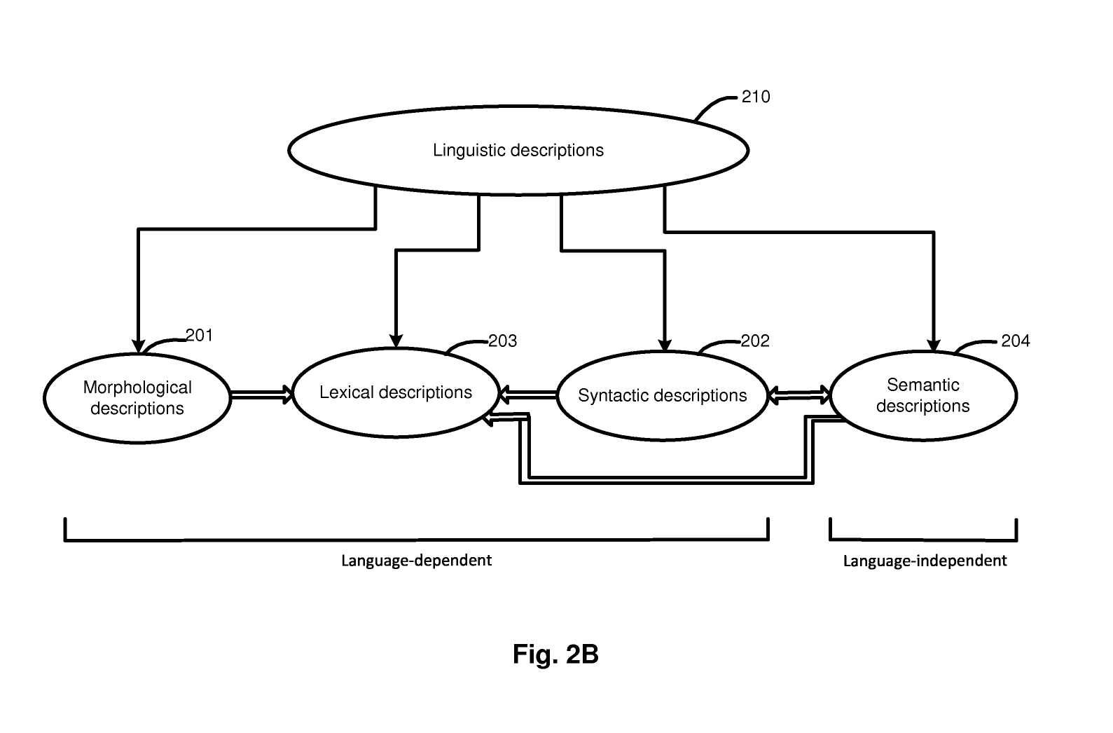

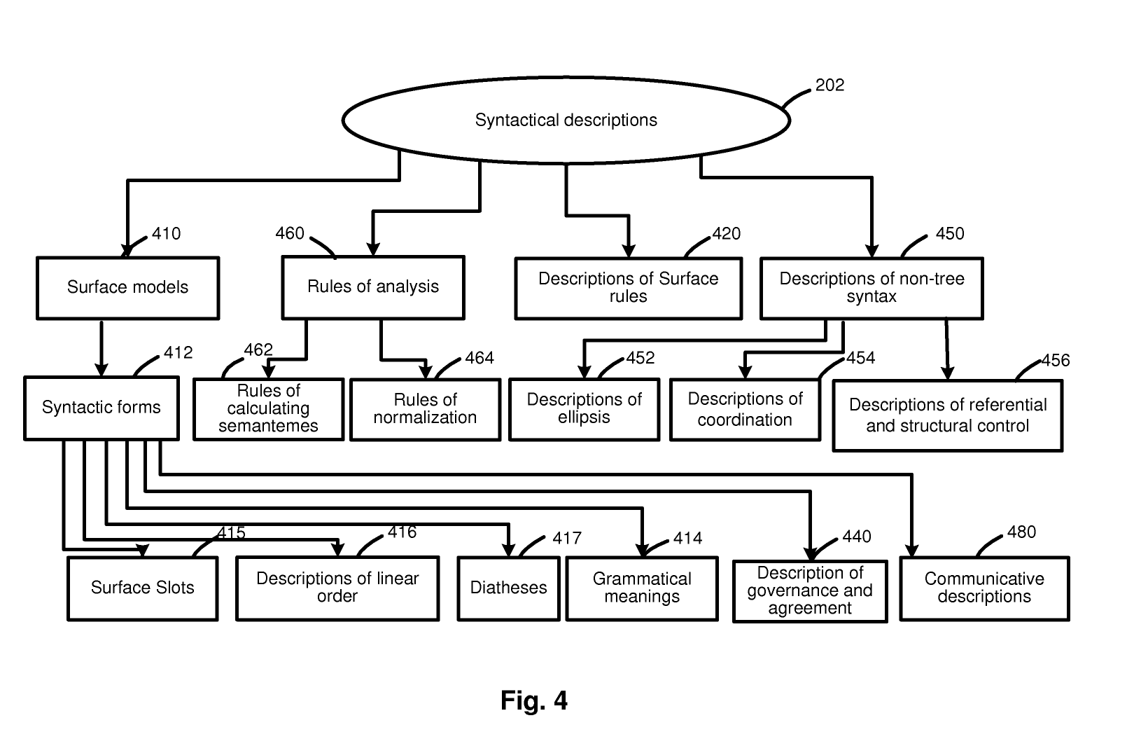

FIG. 1 illustrates the sequence of actions to be performed by the system in accordance with the method of the present disclosure. The input of the system 100 receives a text 110, in the general case a text corpus, each sentence of which at a preliminary stage is transformed by syntactic analysis 120 into a syntactic tree. This stage is rather complex in its realization, and therefore it requires separate explanations which will be provided in the description of FIG. 2. In the next stage 130, non-tree relations are generated in the syntactic trees. The non-tree relations are generated on the basis of models of non-tree syntax, these models being part of the syntactic descriptions of language, which will be illustrated in detail in the description of FIG. 4. Usually there may be rather a lot of variants for establishing these relations, and therefore in stage 140 all of the variants generated are evaluated and ranked (150), and then from the set of mutually exclusive variants the variants with the best rating are selected and in stage 160 an evaluation and ranking (160) is done for the syntactic structures with the selected non-tree relations, after which the method moves on (170) to the semantic structure 180. In addition, at the end of the process in stage 170, an extraction of and identification of entities can be done. The mentioned stages of the process are described in detail below.

FIG. 2 shows a block diagram of the syntactic analysis, whose goal is to construct the syntactic trees (120), which can afterwards be transformed into a universal representation of the information being processed in the form of a set of semantic trees. By the information being processed is meant document texts, data texts, text corpuses, images, as well as that obtained from email servers and social networks, recognized speech, video and other sources. Each indicated action is performed with each sentence of the document, text (212) or message in the corpus of texts. If the processing involves images, files in PDF format or other files requiring recognition, an additional stage of preliminary transformation into text format is added. Any known commercial systems can be used in these stages, such as the program FineReader. In the case of processing voice or audio files, another preliminary stage is added—speech recognition.

In stage 214, for each sentence 212 of text a lexical-morphological analysis is performed, i.e., the morphological meanings of the words of the sentence are identified. In other words, the sentence is broken up into lexical elements, after which their potential lemmas are determined (initial or basic forms), as well as corresponding variants of the grammatical values. Usually a set of variants is identified for each element on account of homonymy and coinciding word forms of different grammatical values. A schematic example of the result of stage 214 for the sentence “This boy is smart, he'll succeed in life” is shown in FIG. 2A.

After this, a syntactic analysis is performed on the lexical-morphological structure. The syntactic analysis is a two-stage process. It includes a rough syntactic analysis 215, involving activation of syntactic models of one or more potential lexical meanings of the particular word being considered and establishing of all potential surface relations in the sentence, which is expressed in the constructing of a data structure known as the graph of generalized constituents. After this, from the graph of generalized constituents in the stage of the fine syntactic analysis 216 there is formed at least one data structure—the syntactic tree—which constitutes the syntactic structure of the sentence. This process is described in detail in the U.S. Pat. No. 8,078,450 incorporated herein by reference in its entirety. In the general case, several such structures are formed, due primarily to the existence of different variants for the lexical selection. Each variant of the syntactic structure has its own proper rating, and the structures are arranged from most likely to least likely.

In all stages of the described method of the present disclosure broad use is made of a large spectrum of linguistic descriptions. A group of these linguistic descriptions and the individual stages of the method of the present disclosure is described below in detail. FIG. 2B is a diagram illustrating the linguistic descriptions (210) according to one aspect.

The linguistic descriptions (210) include morphological descriptions (201), syntactic descriptions (202), lexical descriptions (203) and semantic descriptions (204). Of these, the morphological descriptions (201), lexical descriptions (203) and syntactic descriptions (202) are created for each particular language by defined templates. The semantic descriptions (204) are universal; they are used to describe language-independent semantic features of the different languages and to construct language-independent semantic structures. The linguistic descriptions (210) are interrelated; and they constitute a model of the source language.

Thus, each lexical meaning in the lexical descriptions (203) can also have one or more surface models in the syntactic descriptions (202) for the given lexical meaning. Each surface model in the syntactic descriptions (202) corresponds to a certain deep model in the semantic descriptions (204).

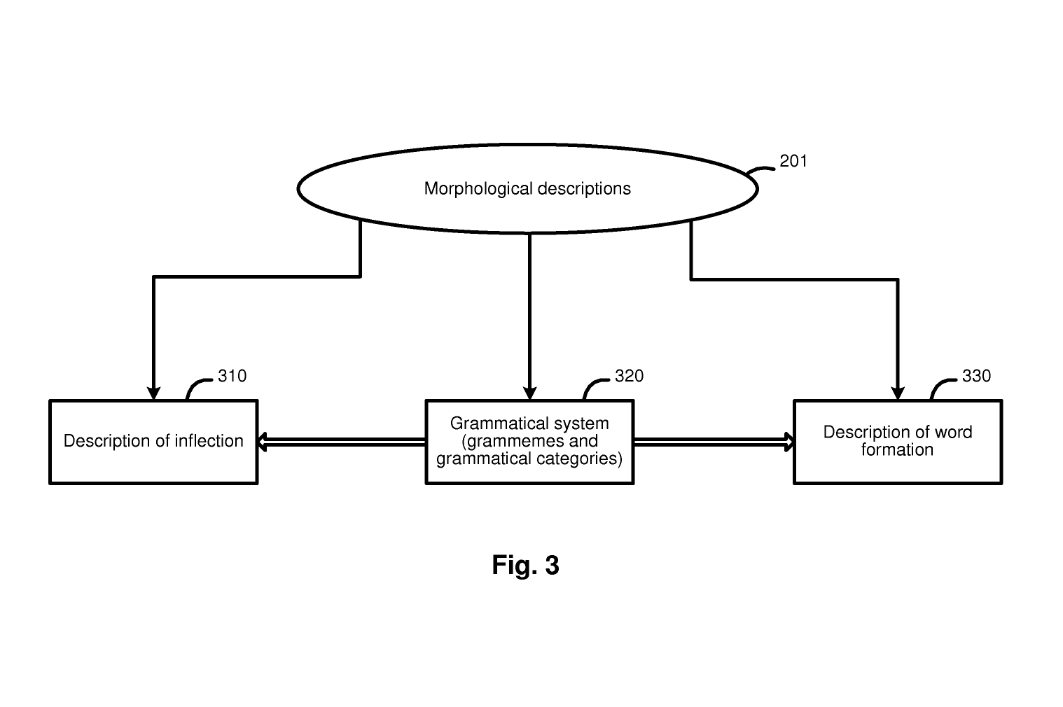

FIG. 3 presents examples of the morphological descriptions. The constituents of the morphological descriptions (201) include: descriptions of inflection (310), the grammatical system (320) and descriptions of word formation (330) and so on. The grammatical system (320) constitutes a group of grammatical categories, such as “part of speech”, “case”, “gender”, “number”, “person”, “reflexivity”, “time”, “aspect”, etc., and each category is a group of meanings, hereafter called “grammemes”, for example including adjective, substantive, verb, and so on; nominative, accusative, genitive case, and so on; feminine, masculine, neuter gender, and so on and so forth.

The description of inflection (310) shows how the basic word form can change according to case, gender, number, time, and so on, and in the broad sense it encompasses or describes all possible forms of this word. Word formation (330) determines which new words can be created with the use of this word (compound words, composites). The grammemes can be used to construct the description of inflection (310) and the description of word formation (330).

Models of constituents are used to establish syntactic relations between elements of the source sentence. A constituent is a group of adjacent words in a sentence, behaving as a single whole. The core of the constituent is a word, and a constituent can also include child constituents on lower levels. A child constituent is a dependent constituent, which can be attached to another (parent) constituent to construct a syntactic structure.

FIG. 4 shows the syntactic descriptions. The syntactic descriptions (202) can encompass, inter alia: surface models (410), descriptions of surface slots (420), referential descriptions and structural control descriptions (430), descriptions of governance and agreement (440), a description of non-tree syntax (450) and rules of analysis (460). The syntactic descriptions 202 are used to construct possible syntactic structures of the source sentence in a given source language taking into account a free linear ordering of words, non-tree syntactic phenomena (such as coordination, ellipsis, etc.), referential relations, and other considerations.

The surface models (410) are presented in the form of collections of one or more syntactic forms (412) for the description of possible syntactic structures of sentences included in the syntactic descriptions (202). On the whole, any lexical meaning in a language is related to surface (syntactic) models (410), presenting constituents which are possible in the case when this lexical meaning plays the role of a “core”, and each surface model includes a set of surface slots of child elements, a description of linear order, diathesis, and so on.

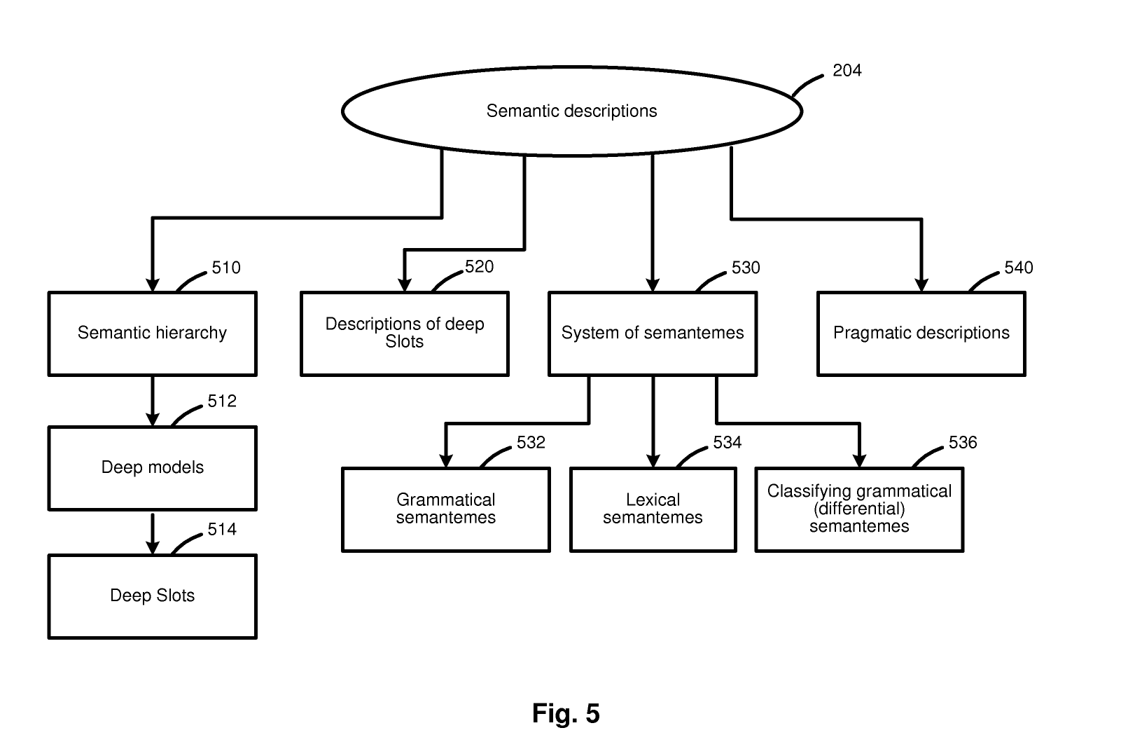

The model of constituents makes use of a group of surface slots (415) of child constituents and descriptions of their linear order (416); it describes the grammatical meanings (414) of possible filler content of these surface slots (415). Diatheses (417) provide the correspondences between surface slots (415) and deep slots (514) (as shown in FIG. 5). Communicative descriptions (480) describe the communicative order in a sentence.

The description of linear order (416) is given in the form of expressions of linear order in order to express a sequence in which different surface slots (415) can occur in a sentence. The expressions of linear order can include the names of variables, the names of surface slots, round brackets, grammemes, ratings, the OR operator, and so on. For example, the description of linear order for the simple sentence “Boys play football” can be represented as “Subject Core Object_Direct”, where “Subject”, “Core” and “Object_Direct” are the names of the surface slots (415) corresponding to the order of the words.

Communicative descriptions (480) describe the order of words in syntactic form (412) from the perspective of communicative acts in the form of communicative expressions of order, which are similar to expressions of linear order. The description of governance and agreement (440) contains the rules and limitations on the grammatical meanings of attached constituents which are used during the syntactic analysis.

Non-tree syntactic descriptions (450) are created for the processing of various linguistic phenomena such as ellipsis and agreement; they are used in transformations of syntactic structures which are created in various stages of the analysis in different aspects. Non-tree syntactic descriptions (450) include the description of ellipsis (452), the description of coordination (454), and also the description of referential and structural control (430).

The rules of analysis (460) are used in the stage of semantic analysis and they describe the properties of a particular language. The rules of analysis (460) may include: rules for calculation of semantemes (462) and rules of normalization (464). The rules of normalization (464) are used as rules of transformation for the description of transformations of semantic structures which may differ in different languages.

FIG. 5 shows a diagram illustrating an example of semantic descriptions. The constituents of the semantic descriptions (204) are not dependent on the language, and they include a semantic hierarchy (510), descriptions of deep slots (520), the system of semantemes (530) and pragmatic descriptions (540).

The core of the semantic descriptions is the semantic hierarchy (510), which consists of semantic concepts (semantic entities), known as semantic classes, arranged in a hierarchical structure in “parent-descendant” relations. A child semantic class inherits the majority of the properties of its direct parent and all the predecessor semantic classes. For example, the semantic class SUBSTANCE is the child semantic class of the class ENTITY and the parent semantic class for the classes GAS, LIQUID, METAL, WOOD_MATERIAL and so on.

Each semantic class in the semantic hierarchy (510) is accompanied by a deep model (512). The deep model (512) of a semantic class constitutes a group of deep slots (514) which reflect semantic roles of the child constituents in different sentences with the objects of the semantic class as the core of the parent constituents, and also possible semantic classes as filler content of the deep slots. The deep slots (514) express semantic relations, such as “agent”, “addressee”, “instrument”, “quantity” and so on. A child semantic class inherits and clarifies the deep model (512) of its parent semantic class.

The deep slots descriptions (520) are used to describe general properties of the deep slots (514), and they reflect the semantic roles of the child constituents in the deep models (512). The deep slots descriptions (520) also contain grammatical and semantic limitations on the filler contents of the deep slots (514). The properties and limitations of the deep slots (514) and their possible filler contents are very similar, often being identical in different languages. Thus, the deep slots (514) are not language-dependent.

The system of semantemes (530) includes a group of semantic categories and semantemes which are the values of the semantic categories. As an example, the semantic category “DegreeOfComparison” can be used to describe the degree of comparison of adjectives, and its semantemes can be, for example, “Positive”, “ComparativeHigherDegree”, “SuperlativeHighestDegree”, and others. As another example, the semantic category “RelationToReferencePoint” can be used to describe the order before or after a reference point; its semantemes can be “Previous”, “Subsequent”, accordingly, and this order can be spatial or temporal in the broad sense of these analyzed words. In yet another example, the semantic category “EvaluationObjective” can be used to describe an objective evaluation, such as “Bad”, “Good”, and so on.

The system of semantemes (530) includes language-independent semantic attributes which express not only semantic characteristics, but also stylistic, pragmatic and communicative characteristics. Certain semantemes can be used to express an atomic value which finds a regular grammatical and (or) lexical expression in the language. By its purpose and usage, the system of semantemes (530) can be divided into different kinds, including grammatical semantemes (532), lexical semantemes (534) and classifying grammatical (differentiating) semantemes (536).

Grammatical semantemes (532) are used to describe grammatical properties of constituents when transforming a syntactic tree into a semantic structure. Lexical semantemes (534) describe specific properties of objects (such as “being flat” or “being liquid”; they are used in descriptions of deep slots (520) as a limitation on the filler contents of the deep slots (for example, for the verbs “face (with)” and “flood”, respectively). Classifying grammatical (differentiating) semantemes (536) express differential properties of objects within the same semantic class; for example, in the semantic class HAIRDRESSER the semanteme “RelatedToMen” is assigned to the lexical meaning “barber”, unlike other lexical meanings which also belong to this class, such as “hairdresser”, “hairstylist” and so on.

It is precisely the use of universal, language-independent semantic features expressed by elements of semantic descriptions—semantic classes, deep slots, semantemes, and so on—in the rules for extraction of information which constitutes an essential difference of the present disclosure as compared to other known methods.

The pragmatic description (540) allows the system to designate a corresponding topic, style or genre for the texts and objects of the semantic hierarchy (510). For example: “Economic policy”, “Foreign policy”, “Legal”, “Legislation”, “Commerce”, “Finance”, and so on. Pragmatic properties can also be expressed by semantemes. For example, the pragmatic context can be taken into account during the semantic analysis.

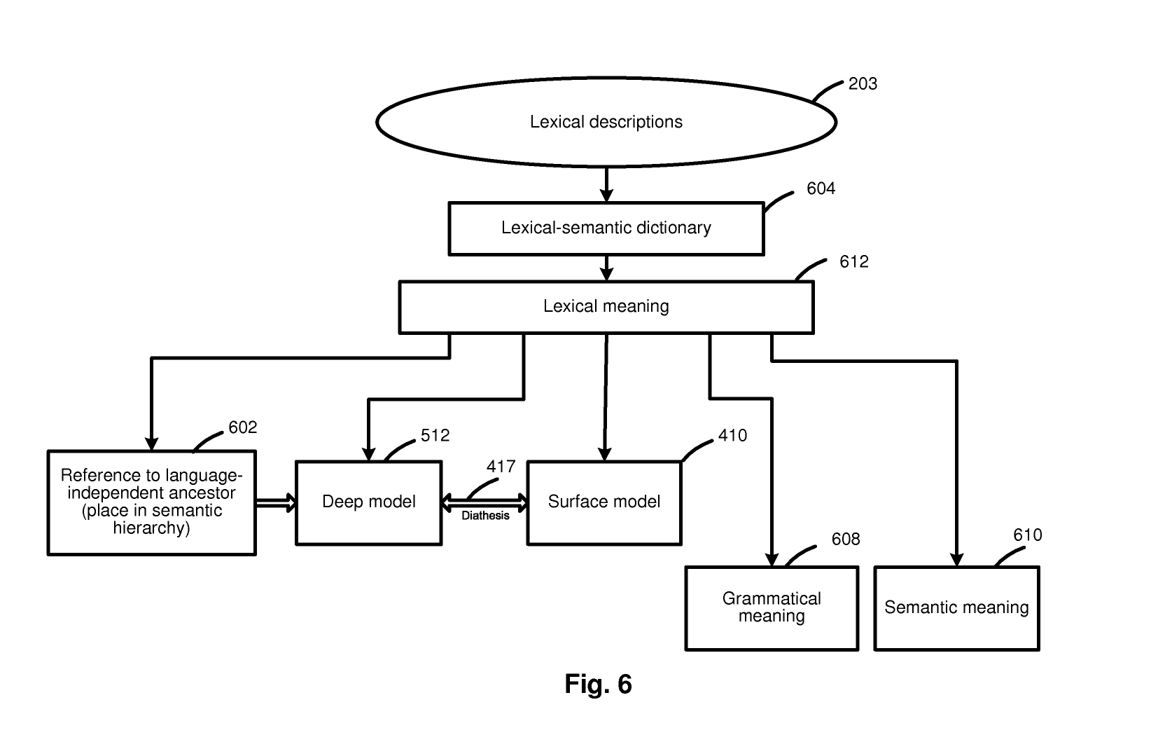

FIG. 6 shows a diagram illustrating the lexical descriptions. The lexical descriptions (203) represent a set of lexical meanings (612) of a particular language for each component of a sentence. For each lexical meaning (612) it is possible to establish a relation (602) with its language-independent semantic parent in order to indicate the position of a particular given lexical meaning in the semantic hierarchy (510).

Each lexical meaning (612) has its own surface model (410), which is related to a corresponding deep model (512) by diatheses (417). Each lexical meaning (612) of a lexical description of a language inherits the semantic class from its parent and clarifies its deep model (512).

Each surface model (410) of a lexical meaning includes one or more syntactic forms (412). Each syntactic form (412) of a surface model (410) can include one or more surface slots (415) with their own descriptions of linear order (416), one or more grammatical meanings (414), expressed in the form of a set of grammatical characteristics (grammemes), one or more semantic limitations on the filler contents of the surface slots and one or more diatheses (417). The semantic limitations on the filler content of a surface slot constitute a set of semantic classes whose objects can occupy that surface slot.

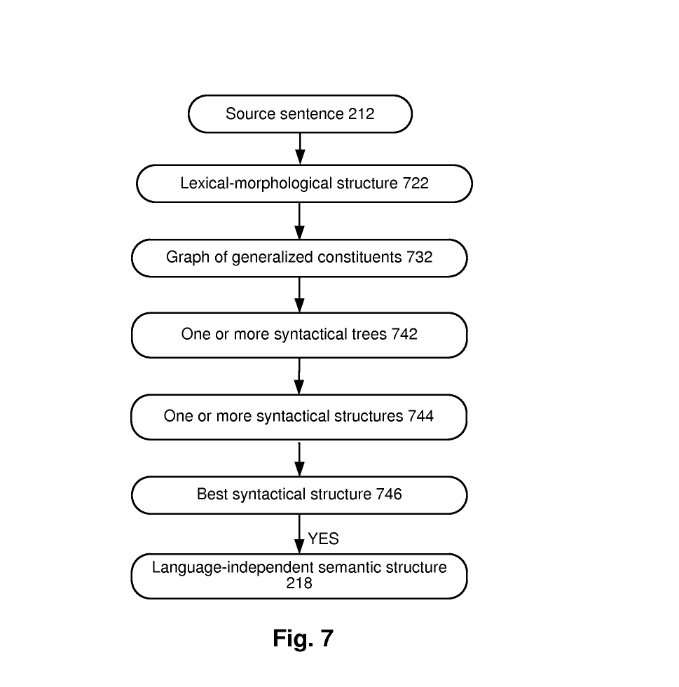

Let us return to FIG. 2, which shows the main stages of the process of semantic-syntactic analysis. In addition, the sequence of data structures which are generated in the analysis process is shown in FIG. 7.

As a preliminary step, the source sentence 212 in the source language is subjected to lexical-morphological analysis 214 to construct the lexical-morphological structure (722) of the source sentence. The lexical-morphological structure (722) is a set of every possible pair of “lexical meaning—grammatical meaning” for each lexical element (word) in the sentence. An example of such a structure is presented in FIG. 2B.

After this, the first stage of the syntactic analysis is done (on the lexical-morphological structure)—the rough syntactic analysis (215) to construct the graph of generalized constituents (732). In the course of the rough syntactic analysis (215), every possible syntactic model of possible lexical meanings is applied to each element of the lexical-morphological structure (722) and they are checked to find every potential syntactic relation in this sentence, which relations are reflected in the graph of generalized constituents (732).

The graph of generalized constituents (732) is an acyclic graph, whose nodes are generalized constituents (that is, holding all variants), while its branches are the surface (syntactic) slots expressing different types of relations between the generalized lexical meanings. All of the potentially possible surface syntactic models are checked for each element of the lexical-morphological structure of the sentence as a potential core of the constituents. Next, all possible constituents are constructed and generalized into the graph of generalized constituents (732). Accordingly, every possible syntactic model and syntactic structure of the source sentence (212) is considered, and as a result on the basis of the set of generalized constituents there is constructed the graph of generalized constituents (732). The graph of generalized constituents (732) on the level of the surface model reflects all potential relations between the words of the source sentence (212). Since the number of variations of syntactic parsing may be large in the general case, the graph of generalized constituents (732) is redundant, having a large number of variations both in regard to the choice of lexical meaning for the node and in regard to the choice of surface slots for the branches of the graph.

The graph of generalized constituents (732) is initially constructed in the form of a tree, starting with the leaves and working toward the root (from bottom to top) by adding child components to the parent constituents; these fill in the surface slots (415) of the parent constituents in order to encompass all the lexical units of the source sentence (712).

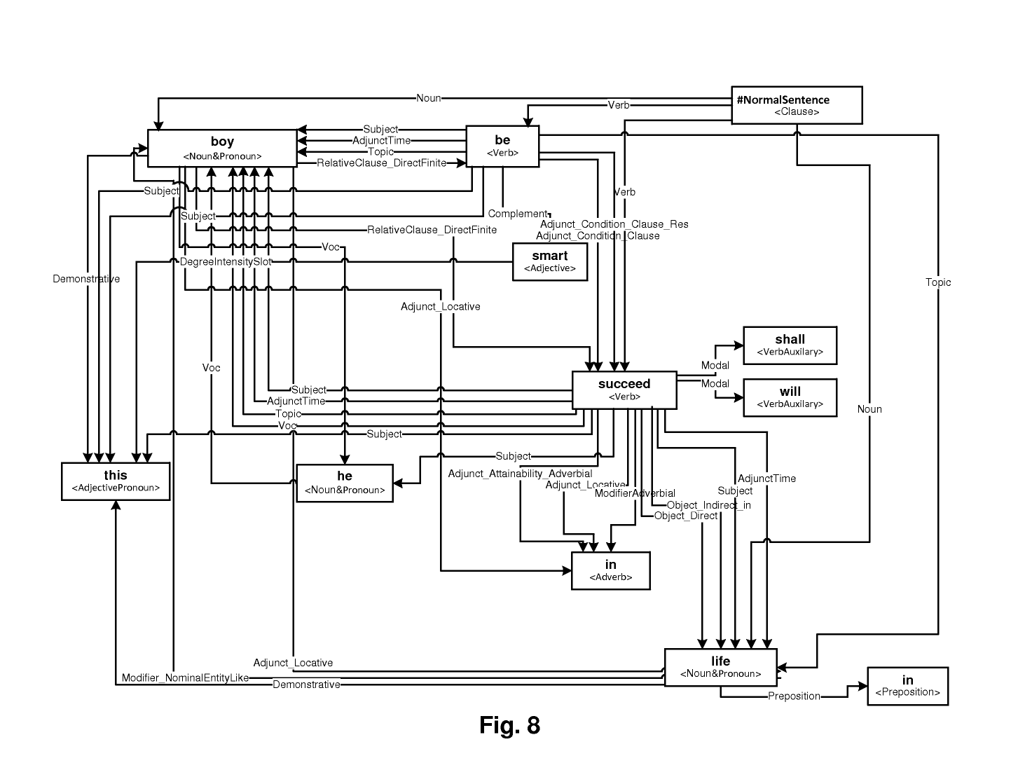

As a rule, the root of the tree, which is the chief node of the graph (732), is a predicate. In the course of this analysis, the tree usually becomes a graph, since the constituents of lower level can be included in several constituents of higher level. Several constituents constructed for identical elements of the lexical-morphological structure can afterwards be combined to produce generalized constituents. The constituents are generalized on the basis of the lexical meanings or grammatical meanings (414), for example, based on the parts of speech and the relations among them. FIG. 8 shows a schematic example of a graph of generalized constituents for the previously mentioned sentence: “This boy is smart, he'll succeed in life”.

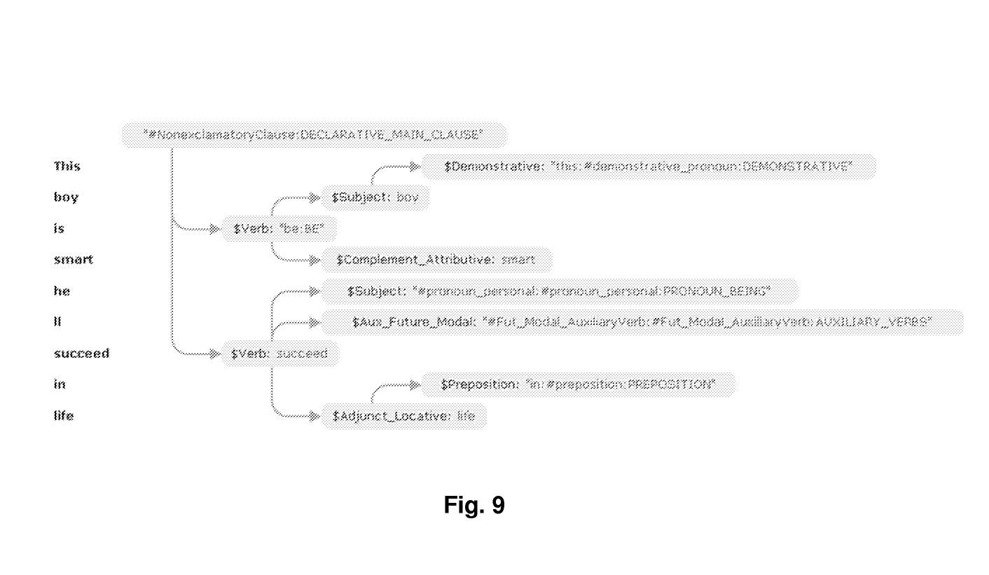

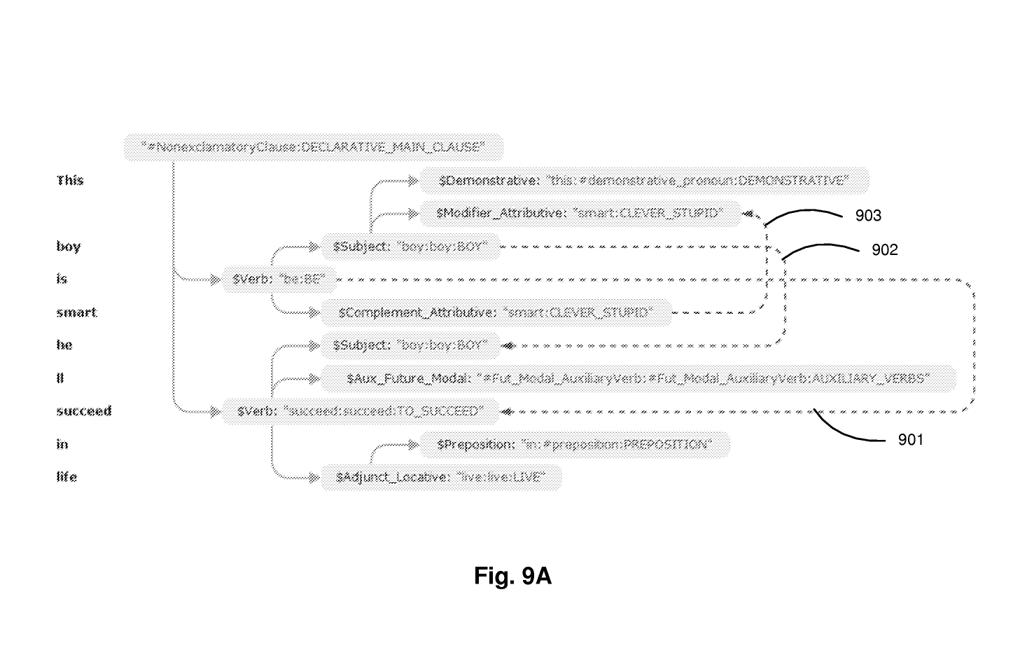

Precise syntactic analysis (216, FIG. 2) is done to pick out the syntactic tree (742) from the graph of generalized constituents (732). One or more syntactic trees are singled out (218, FIG. 2), and for each of them a general rating is computed on the basis of the use of a group of prior and calculable ratings. The syntactic trees are ranked from the tree with the best rating to the least probable trees. In one possible aspect, a certain threshold value can be chosen for the rating to exclude “bad” trees which will not be further considered. Thus, at this stage in the general case there is a certain set of syntactic trees. The generating, calculating of ratings, and processing of the syntactic trees can be done independently, including in parallel on different computer devices in a computer system, including with the use of a client-server system and so forth. FIG. 9 shows an example of one of the syntactic trees for the previously mentioned sentence: “This boy is smart, he'll succeed in life”.

The syntactic trees are formed in the process of putting forward and verifying hypotheses as to the possible syntactic structure of the sentence, in this process hypotheses as to the structure of the parts of the sentence are formed in the context of a hypothesis as to the structure of the overall sentence.

Now let us return to FIG. 1. In stage 130, non-tree relations are generated in the process of moving from the selected syntactic tree to the syntactic structure (746). In the general case, for each syntactic tree there is a certain number of variants for establishing the non-tree relations, and therefore in stage 130 (FIG. 1) a number of variants for establishing non-tree relations can be generated for each (one or more) syntactic tree. In stage 140 ratings of the variants of non-tree relations are calculated for one or more syntactic trees, in fact a set of syntactic structures 744, which are “candidates” for producing the best syntactic structure 746, are considered. In stage 150 the variants of the non-tree relations are ranked for each (one or more) of the syntactic trees. For each syntactic structure, an estimate is calculated taking into account the established non-tree relations, and the syntactic structures obtained on the basis of one or more syntactic trees are ranked (160) in accordance with the estimate obtained. The structure with the best estimate is chosen. Thus, the outcome of the precise analysis (216, FIG. 2) is a syntactic structure (746) which is considered to be the best syntactic structure of the sentence being analyzed. Actually, a lexical selection is done at the same time as a result of the choice of the best syntactic structure (746), i.e., a determination of the lexical meanings of the elements of the sentence. We shall consider several examples to illustrate the non-tree relations.

Next, in stage 170 (FIG. 1) there is a transition to a language-independent semantic structure, which reflects the sense of the sentence in universal, language-independent terms. The language-independent semantic structure of the sentence is presented in the form of an acyclic graph (a tree, supplemented with non-tree relations), while the words in the particular language are presented therein by nodes labeled with universal (language-independent) semantic entities—the semantic classes of the semantic hierarchy (510), while the arcs correspond to semantic (deep) relations. This transition occurs by applying the rules of analysis (460), as a result of which the semantic classes are accompanied by sets of attributes (the attributes express lexical, syntactic and semantic properties of the particular words of the source sentence).

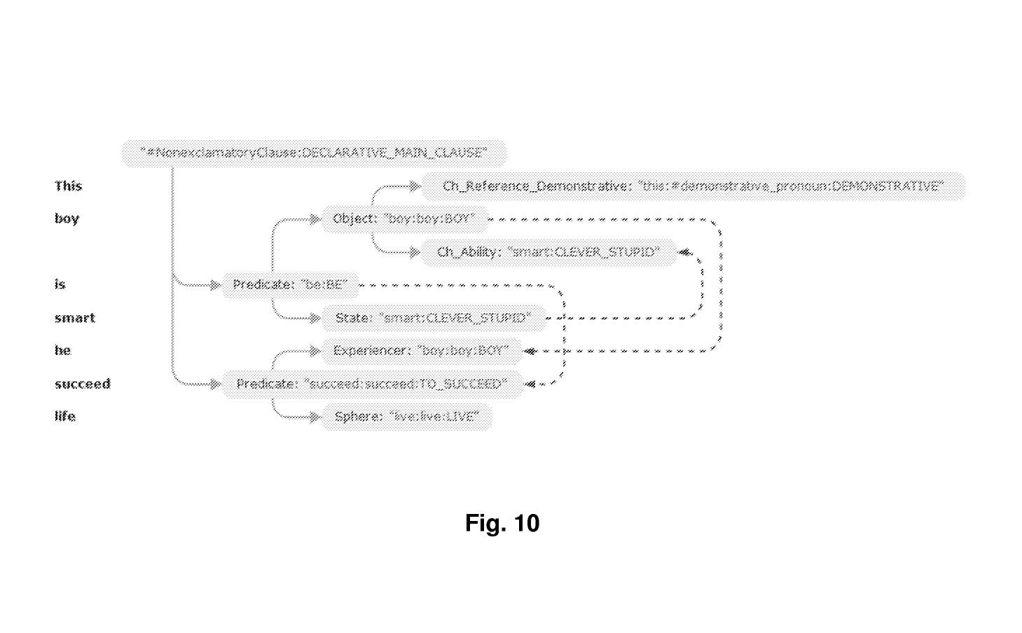

FIG. 9A shows a syntactic structure with established non-tree relations for the previously mentioned sentence “This boy is smart, he'll succeed in life”. The relation 901 demonstrates a coordination, 902 a pronoun anaphora, and 903 a kind of auxiliary link allowing for the collection of statistics and the creation of agreement in those languages where this is needed. FIG. 10 shows the corresponding semantic structure.

Let us consider stage 130 more closely (FIG. 1), in particular, the rules letting us establish non-tree relations. One or another rule of analysis will be used, depending on the type of anaphoric relation.

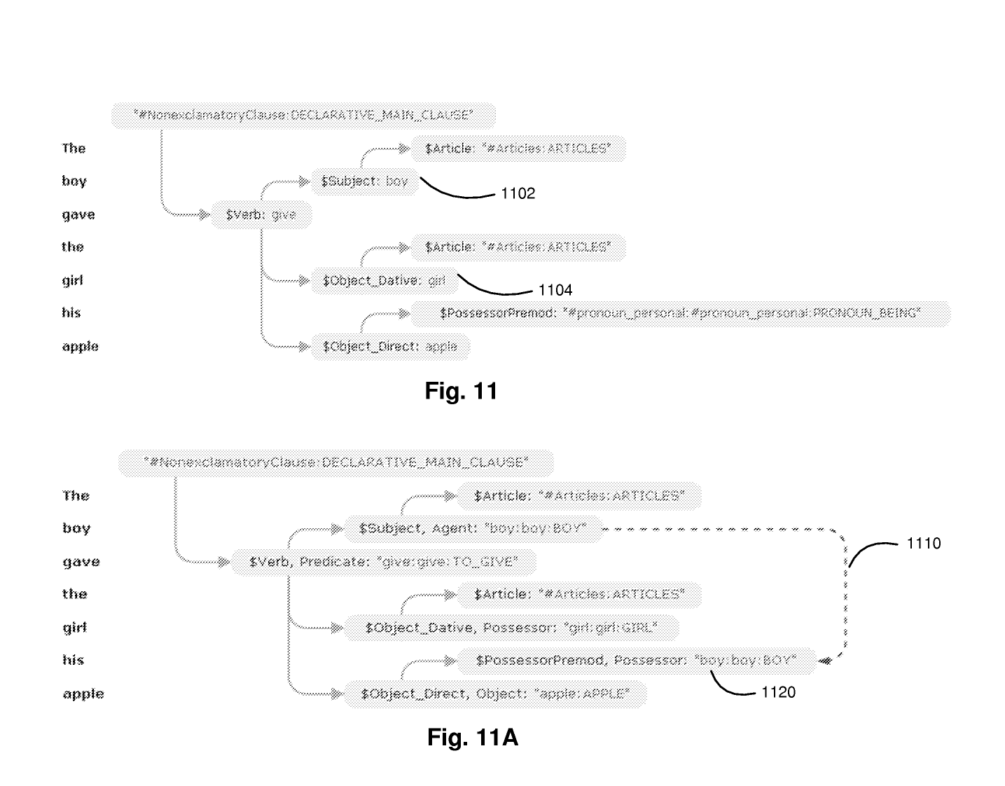

For example, as a result of the syntactic analysis of the sentence “The boy gave the girl his apple”, the syntactic tree shown in FIG. 11 is obtained. However, there exists in this sentence, but not expressed in the syntactic tree, a semantic relation between the words “boy” and “his”, indicating that the boy gave precisely his apple, and not somebody else's or simply any other one, such as one lying on a plate or plucked from a tree. This relation can and should be established, as shown in FIG. 11A and expressed by the dotted arrow 1110, yet doing so requires certain nontrivial actions. Furthermore, the possessive pronoun expressed by the node “his” is replaced by the node “boy” (1120), which is a non-tree controller and plays a semantic role of Possessor. In order to establish the relation 1110, the syntactic model should contain a description of this non-tree relation. The description of such a non-tree relation can be linked to a description of a lexical meaning, a lexeme, a pronoun, or to a description of a surface slot; it can also be found among the descriptions of referential control (456, FIG. 4) etc.

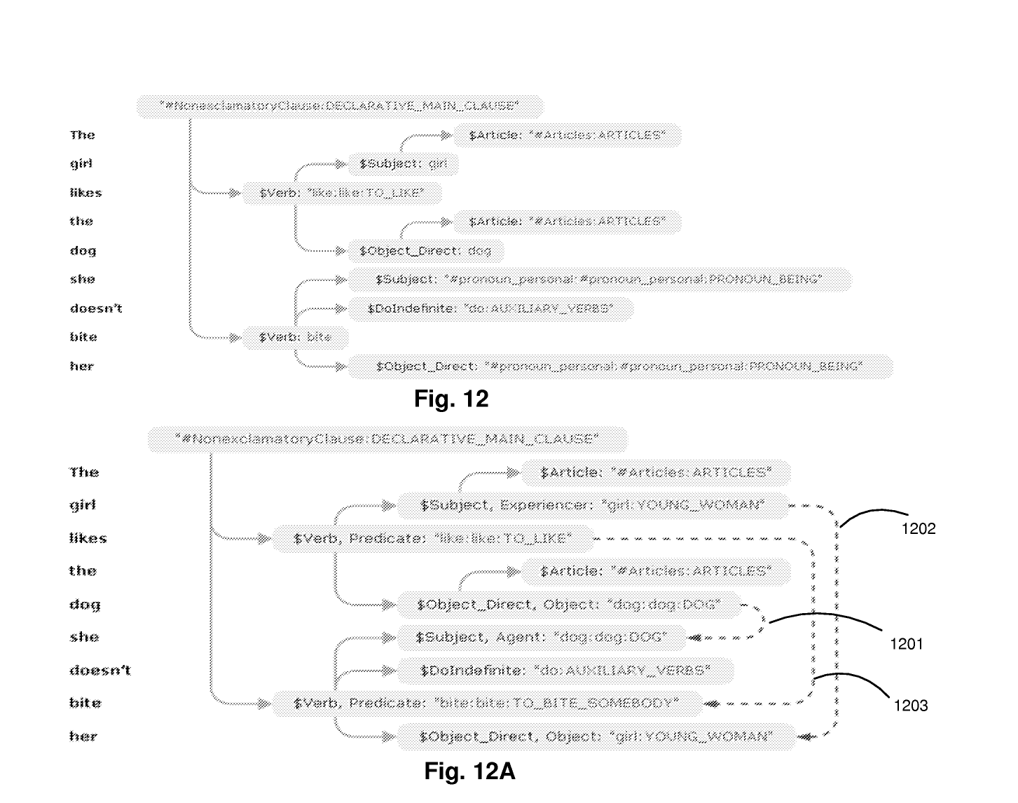

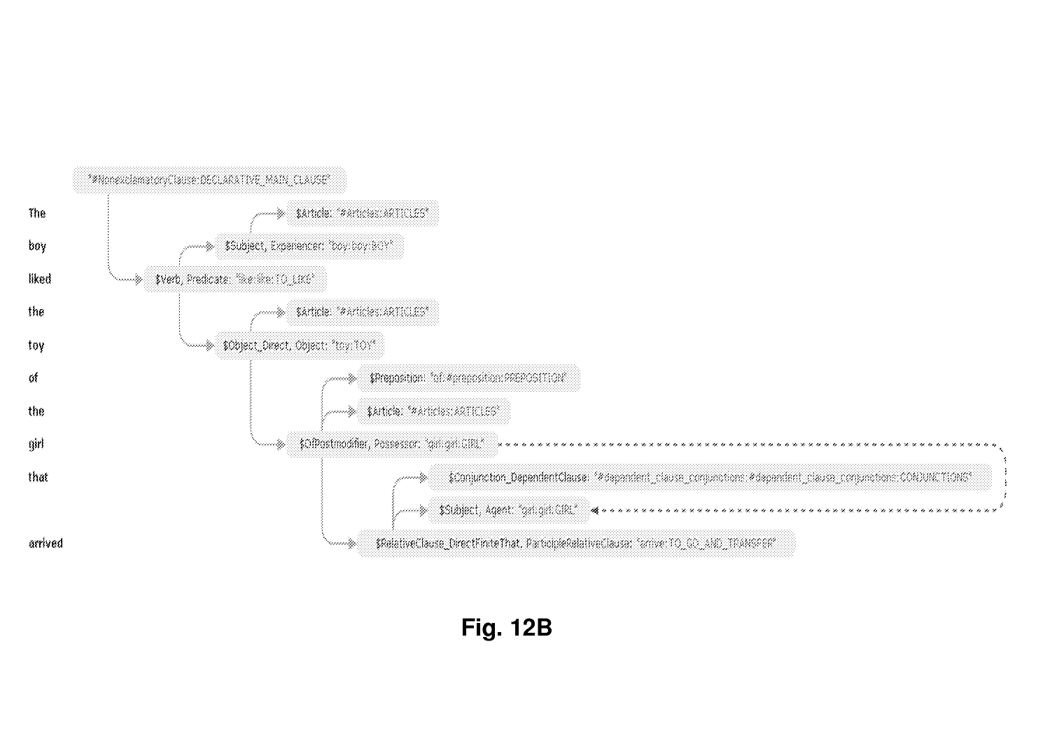

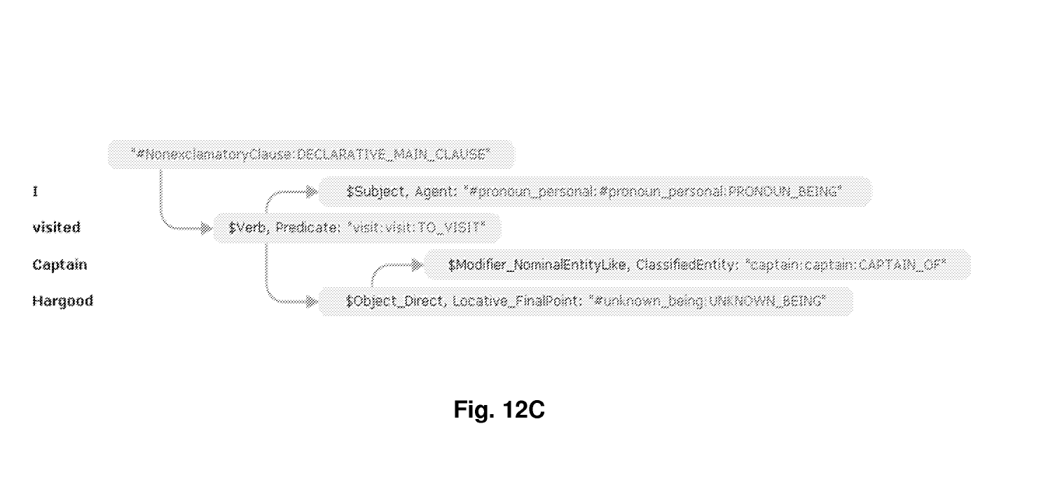

However, the determination of the controller and, consequently, the choice of the deep slot of the controller are not always unambiguous. FIG. 12 and FIG. 12A show the outcome of a parsing of a second sentence, “The girl likes the dog, she doesn't bite her”, with no non-tree relations and with non-tree relations established, respectively. Here again there is a replacement of the node “she” by the controller “dog”, and “her” by “girl”.

Any given rules of analysis will be applied depending on the type of anaphoric relation. The rules for resolution of a pronoun anaphora are applied if a certain kind of pronoun occurs in the text: he, she, it, they, I, we, you, (my/your/him/her/it)self, one's, one another, such and certain others. Every such rule contains at least the following components:

a list of pronouns which trigger this rule;

a description of a possible path, preferably via surface slots, from a possible controller to the pronoun (the controller is the object which is replaced by the pronoun in the text);

a description of allowable properties of the controller;

a rule for the agreement of the controller and the pronoun;

the direction of the relation (controller is to the left or right of the pronoun);

the weight of the relation.

For example, in the example presented in FIG. 11 (The boy gave the girl his apple), the appropriate rule selects the node with the surface slot $Subject (“boy”—1102) as the controller, since the corresponding rule describes a possible path from the element with the surface slot $Subject, but does not describe as possible the path from $Object_Dative (1104). The description of the possible properties of the controller may involve, for example, not allowing certain words and phrases as the controller. The node 1120 is the result of the replacement of “his” with “boy” in the process of establishing the anaphoric relation 1110.

In the sentences “The boy loves the girl. She is pretty.” the anaphora is resolved unambiguously, since the rule of agreement presupposes an agreement of the pronoun and the controller in gender and number.

Let us consider the sentence “The girl likes the dog, she doesn't bite her”. Initially, as a result of the analysis, a syntactic tree with no non-tree relations is obtained, shown in FIG. 12. Next, as soon as the system comes upon the pronouns (she, her) in this text fragment, the rules of anaphora resolution are triggered and the following relations are produced:

link 1: Proform “she”; ProformParent “bite”; ProformSlot Object_Direct; Controller “girl”

link 2: Proform “she”; ProformParent “bite”; ProformSlot Object_Direct; Controller “dog”

link 3: Proform “she”; ProformParent “bite”; ProformSlot Subject; Controller “girl”

link 4: Proform “she”; ProformParent “bite”; ProformSlot Subject; Controller “dog”

In stage 130, all possible non-tree relations are initiated; however each pronoun can only have one controller. The system tries to apply all possible variants of replacement of a pronoun with a corresponding controller and select the semantic roles (deep slots) for them. This generates an entire set of possible syntactic structures (with substituted pronouns). Each of these structures is given a certain integral rating, depending on the semantic and syntactic compatibility with other elements of the sentence. The structures are ranked and the structure with the best rating is chosen as the result of the analysis. An example of the best structure with non-tree relations is shown in 12A.

In FIG. 12A the pronoun “she” is replaced by its controller “dog” in the semantic role of Agent, and the corresponding anaphoric relation is shown by the dotted arrow 1201. In turn, the pronoun “her” is replaced by the controller “girl” in the semantic role of Agent, and the corresponding anaphoric relation is shown by the dotted arrow 1202. Another non-tree link 1203 represents coordination.

A relative anaphora is encountered in sentences containing a noun phrase and relative pronoun, such as “The boy who arrived.”

Relations of this type are described by the same rules as for a pronoun anaphora, except that if a controller is not found for a certain relative pronoun the entire structure is rejected. The relative pronouns in the semantic structure are likewise replaced by their controllers in the corresponding semantic roles, which is likewise oriented to selecting the best among possible candidates, based on semantic compatibility. The range of possible candidates in the case of a relative pronoun is generally narrower, since the controller of the relative pronoun should directly govern the corresponding relative clause, although here as well ambiguities are possible. For example, “The boy liked the toy of the girl that arrived.” To resolve this ambiguity, the system must be aware that girl can arrive with greater likelihood than toy. This information can only be obtained by considering the semantic compatibility.

The semantic structure of this sentence is shown in FIG. 12B, where the node that is replaced by girl in the semantic role of Agent. The structure where toy fills the predicate slot arrive is also considered as potentially possible, but rejected due to a low rating.

Anaphora is one example of a more complicated problem—co-reference. Co-reference is an attempt to relate several different references in a text to the same real object. The problem is complicated if the noun phrases do not have text overlap, such as Obama and President of the USA (Obama and Barack Obama is a relatively simple case). This problem correlates with the problem of named entities recognition (NER) and extracting facts from texts.

In the recognition of named entities, usually collections of persons, locations, and organizations are used. One of the heuristic approaches consists in that, if the named entity, i.e., the proper noun, is used together with (alongside) a common noun, then at least for the remainder of the given text they can be identified completely or even sometimes partially. For example, if there is the combination President of the USA Barack Obama in a text, it can be assumed that President of the USA=Barack Obama and President of the USA=Obama. The simplest approach in recognizing the names of persons involves the use of lists of names and the identification of capitalization of the first letter of a word. However, lists might not be complete, capitalization is not a dependable method, there are many homonymic names (such as Bob, Virginia, Slava [homonym for ‘glory’ in Russian]), and a proper noun can also refer to the name of an entity other than a person. For example, the steamship “Ivan Fedorovich Kruzenshtern”, the “Pushkin” restaurant, and so on. Finally, a reference to a person may be expressed by a common noun or noun phrase of general form, such as boy, man, cosmonaut, head of state, state senator.

In the general case, a proper noun may be absent from the dictionary. In this case, semantic-syntactic analysis helps establish this reference in the semantic-syntactic structure. If a certain node in the tree as a result of analysis is labeled UNKNOWN_BEING (i.e., no semantic class was determined for it), the system analyzes the parent node in the tree, i.e., the node which governs the given one and whose descendant is UNKNOWN_BEING. An example of such a tree for the sentence “I visited Captain Hargood” is shown in FIG. 12C. If this parent node turns out to be the title of a profession, a rank, a title, and so on, a particle indicating noble birth (von) or Lady, Mister, Miss, Madam, Senor, and so on, there is a high chance that a controlled node is a surname or a person's name.

Other markers of persons may include, for example, an indication of year of birth (Helmholtz, b. 1989), place of birth, organization (such as place of work), parenthetical constructions with foreign words (Khieu Porn (Kxuey [symbol] opH) became the victim of his countrymen), location, country (Vic Wild (Russia)—1st place), and also the presence of certain specific verbs (get married, become engaged, and so on). The presence in close context—it can be the same or a neighboring (closely situated) sentence—of other words indicating a “person”, such as “sportsman”, “prime minister”, “cosmonaut”, “actress”, “girl”, and so on, as well as demonstrative pronouns such as “this” and so on, allows of constructing and testing hypothesis of an identification with other nouns and noun phrases. In English, for example, the presence of the definite article before a substantive allows almost unambiguously link the entity with its preceding mention. Corresponding methods exist for the extraction of locations, names of organizations, and so forth.

The problem is complicated if there are several variants for the identification of entities. However, the use of the above-described technology of semantic-syntactic analysis offers major advantages in the resolution of co-reference. The essence of the approach in the given case comes down to two stages: 1) identification and 2) filtration. In the course of the first stage, pairs are singled out for identification; in the second stage, attributes of the elements of the pairs are compared in order to find those which coincide or are the closest.

The possibility of analyzing the syntactic structure of a sentence obtained as a result of the working of a parser and the values identified for the parameters (attributes) of the units of this sentence, such as gender, number, etc., make it possible, for example, to distinguish the entities.

In addition to the use of rules based on syntactic models, semantic restrictions can be taken into account. For example, if a certain node of the syntactic-semantic structure with a subordinate node representing a “person” as the object has a nominal complement, the system establishes a special supplemental link from the object to this complement. Then, if this same lexeme is encountered anywhere else in the text as complement, the second “person’ will be identified and merged with the first by this special link (two person objects will merge due to that special link). For example, there is the problem of identifying the entities Bjorndalen=biathlete=sportsman in the following example:

Bjorndalen is a great biathlete. The sportsman showed the highest class at the Olympics in Sochi. A biathlete of this level cannot be written off even after 40 years.

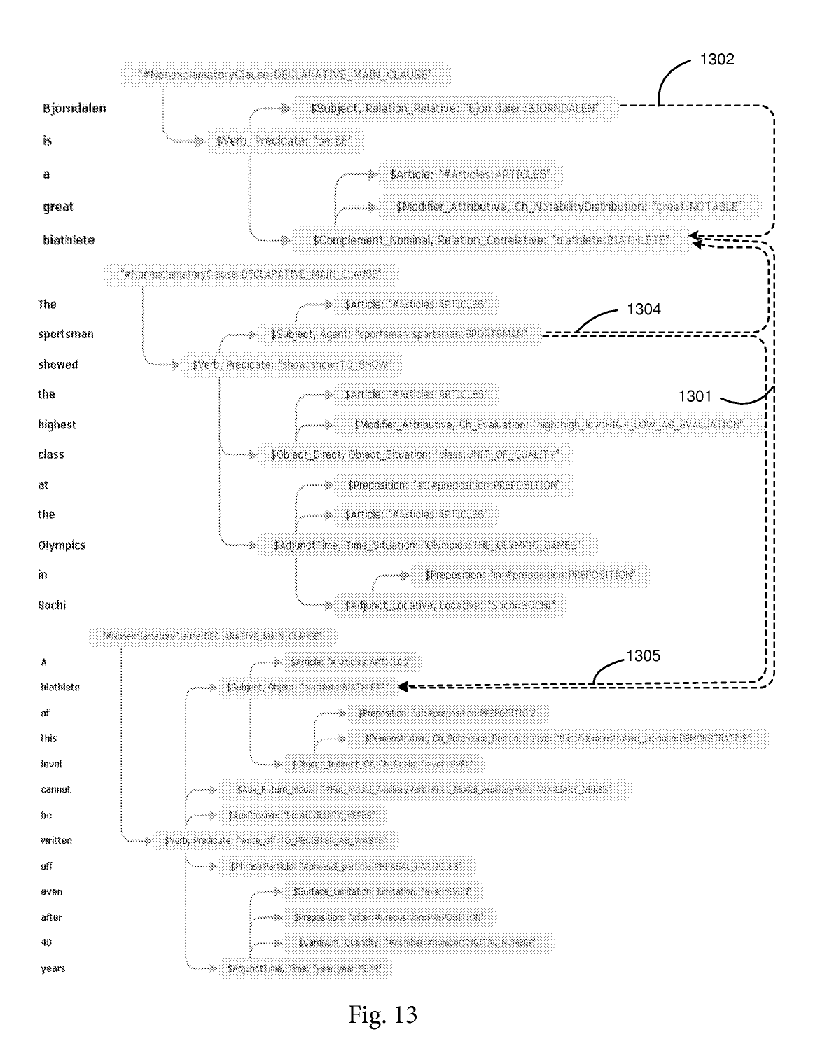

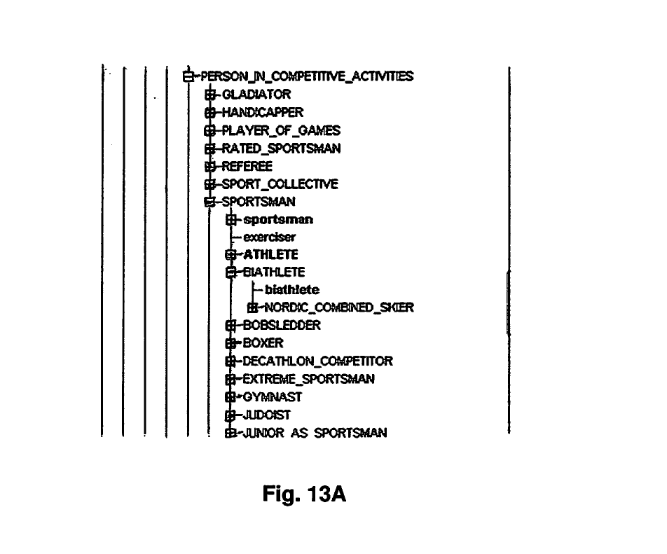

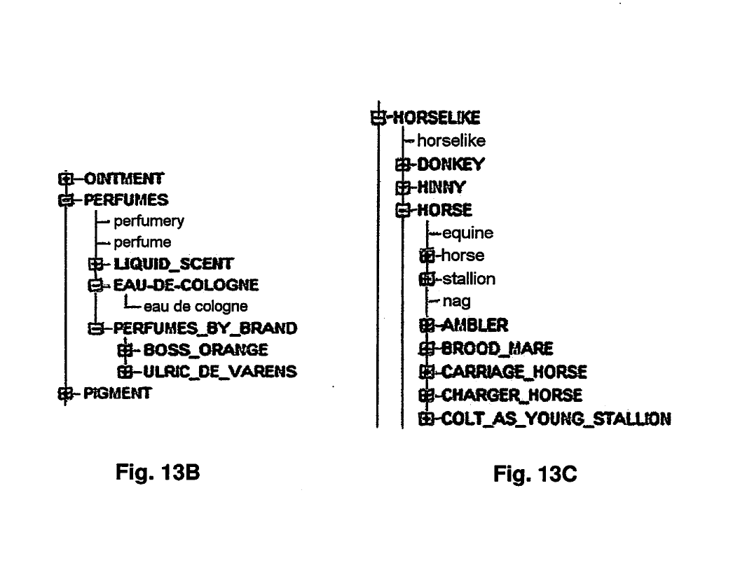

An illustrative example of establishing referential links on a set of syntactic trees presenting these sentences is shown in FIG. 13. First of all, the extraction rules identify three entities: “Bjorndalen”, “biathlete”, and a second “biathlete”. The two “biathlete” mentions are merged into a single entity (relation 1301) on the basis of belonging to the same semantic class and after the syntactic structure of the first sentence indicates an identification of the first “biathlete” occurrence with the surname Bjorndalen (relation 1302).

In order to reconstruct the entire co-reference chain, the link between “biathlete/Bjorndalen” to “sportsman” (links 1304 and 1305) should be established.

In one possible aspect, grammatical attributes (gender, number, animacy, and so on) can be used for the filtering of the pairs, and the metric of semantic closeness in the aforementioned semantic hierarchy is also used. In this case, the “distance” between the lexical meanings can be estimated. FIG. 13A shows a fragment of the semantic hierarchy with the lexical meanings “biathlete” and “sportsman”. These are found in the same “branch” of the tree of the semantic hierarchy and “biathlete” is found in the singled-out semantic class BIATHLETE, which in turn is a direct descendant of the semantic class SPORTSMAN, while “sportsman” is directly included in this same class SPORTSMAN. That is, “biathlete” and “sportsman” are situated “close” in the semantic hierarchy, they have a common “ancestor”—the semantic class SPORTSMAN, and moreover “sportsman” is its representative member and in this sense a hyperonym in regard to “biathlete”. Speaking informally, to move from “biathlete” to “sportsman” in the semantic hierarchy no more than a few steps should be made. The metric can take account of the affiliation with the same semantic class, the presence of a closely located common ancestor—the semantic class, the representativeness, the presence/absence of certain semantemes, and so on.

Moreover, an indicator of a possible referential link is the presence of the demonstrative pronoun “this”, “that”, (“these”, etc.). For example, (horse—this nag; apparition—that very spirit hostile to him; apparatus—this device). In English, the definite article “the”, and also “this”, “these”, “that”.

The approach is easily extended to the task of establishing referential links not only during the analysis and extraction of named entities, but also arbitrary objects of the real world.

For example: I recall a remarkable episode when she boasted to us of some expensive eau de cologne which she bought for the young husband. We asked to sniff this perfume.

The fragment of the semantic hierarchy is shown in FIG. 13B. The semantic class “eau de cologne” (EAU-DE-COLOGNE) is a direct descendant of the class “perfume” (PERFUMES, which also includes “perfumery”), which lets these two objects be united. The demonstrative pronoun “which” is replaced by its controller “eau de cologne”, and also included in the chain of co-reference.

Another example: Soon the other spectators also saw the dreadful nag, as if escaped from the knacker's yard. People laughed, gaped, wondered, became indignant. How could this horse turn up here?

In the semantic hierarchy, whose fragment is shown in FIG. 13C, “horse” and “nag” are found in the same semantic class HORSE, while “nag” is a stylistically colored synonym for “horse”. The rule of establishing a referential link based on the presence of a demonstrative pronoun and closeness in semantic hierarchy is also applicable in this case.

Thus, predetermined lists of entities need not be used in the described approach; the approach uses a universal measure of similarity, based on the hierarchical representation of a set of objects of the real world and the calculation of the measure of their closeness in the given graphic representation. The aforementioned semantic hierarchy (510, FIG. 5) can be used as this hierarchical representation.

Analogously to the establishing of anaphoric non-tree relations, the problem of establishing referential links within several sentences is also solved in two stages. In the first stage, all possible candidates or pairs of potentially identifiable objects are singled out, and in the second stage these pairs are estimated and ranked in accordance with the chosen measure of closeness.

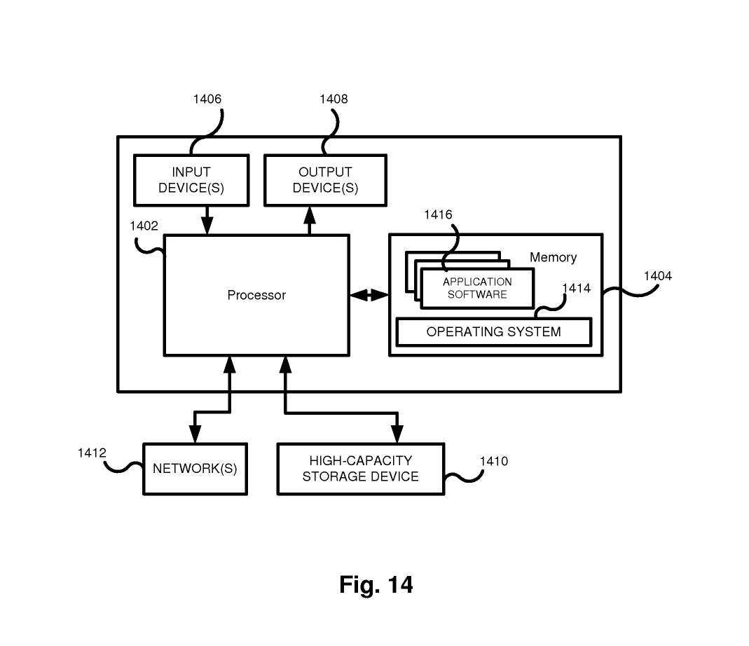

FIG. 14 shows a diagram of hardware (1400) which can be used to implement the present disclosure. The hardware (1400) should include at least one processor (1402) connected to a memory (1404). The term “processor” in the diagram (1402) can denote one or more processors with one or more computing kernels, a computing device, or any other CPU on the market. The symbol 1404 denotes a working storage (RAM), which is the main storage (1400), and also additional memory levels—cache, power-independent, backup memory (such as programmable or flash memory), ROM, and so on. Furthermore, the term memory (1404) can also mean a storage residing in another part of the system (such as the cache of the processor (1402) or another storage used as virtual memory, such as an internal or external ROM (1410).

The hardware (1400) as a rule has a certain number of inputs and outputs for transmittal and receiving of information from the outside. The user or operator interface of the software (1400) can be one or more user entry devices (1406), such as keyboard, mouse, imaging device, etc., and also one or more output devices (liquid crystal or other display (1408)) and sound reproduction (dynamics) devices.

To obtain an additional volume for data storage, one uses data collectors (910) such as diskettes or other removable disks, hard disks, direct access storage devices (DASD), optical drives (compact disks etc.), DVD drives, magnetic tape storages, and so on. The hardware (1400) can also include a network connection interface (1412)—LAN, WAN, Wi-Fi, Internet and others—for communicating with other computers located in the network. In particular, one can use a local-area network (LAN) or wireless Wi-Fi network, not connected to the worldwide web of the Internet. It must be considered that the hardware (1400) also includes various analog and digital interfaces for connection of the processor (1402) and other components of the system (1404, 1406, 1408, 1410 and 1412).

The hardware (1400) runs under the control of an Operating System (OS) (1414), which launches the various applications, components, programs, objects, modules, etc., in order to carry out the process described here. The application software should include an application to identify semantic ambiguity of language. One can also include a client dictionary, an application for automated translation, and other installed applications for imaging of text and graphic content (text processor etc.). Besides this, the applications, components, programs and other objects, collectively denoted by the symbol 916 in FIG. 13, can also be launched on the processors of other computers connected to the hardware (1400) by a network (1412). In particular, the tasks and functions of the computer program can be distributed between computers in a distributed computing environment.

All the routine operations in the use of the implementations can be executed by the operating system or separate applications, components, programs, objects, modules or sequential instructions, generically termed “computer programs”. The computer programs usually constitute a series of instructions executed at different times by different data storage and memory devices on the computer. After reading and executing the instructions, the processors perform the operations needed to initialize the elements of the described implementation. Several variants of implementations have been described in the context of fully functioning computers and computer systems. The specialists in the field will properly judge the possibilities of disseminating certain modifications in the form of various program products on any given types of information media. Examples of such media are power-dependent and power-independent memory devices, such as diskettes and other removable disks, hard disks, optical disks (such as CD-ROM, DVD, flash disks) and many others. Such a program package can be downloaded via the Internet.

In the specification presented above, many specific details have been presented solely for explanation. It is obvious to the specialists in this field that these specific details are merely examples. In other cases, structures and devices have been shown only in the form of a block diagram to avoid ambiguity of interpretations.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the concepts disclosed herein.

1. A method for creating syntactic-semantic structures of natural language sentences in natural language processing of a natural language text, comprising:
generating by a hardware processor at least one syntactic tree for each sentence including a plurality of syntactic nodes and a plurality of tree-like syntactic relations;
generating by a hardware processor at least one semantic structure corresponding to the at least one syntactic tree,
wherein the at least one semantic structure includes a plurality of semantic nodes corresponding to the plurality of syntactic nodes and a plurality of tree-like semantic relations corresponding to the plurality of tree-like syntactic relations;
if the at least one syntactic tree includes at least two different syntactic nodes corresponding to a single entity, then connecting the semantic nodes corresponding to the at least two different syntactic nodes by at least one non-tree link; and
performing by the hardware processor further natural language processing of the text using the semantic structure comprising the at least one non-tree link.

2. The method of claim 1, wherein the connecting of the semantic nodes by the at least one non-tree link comprises:
generating a plurality of possible non-tree links between the syntactic nodes;
calculating a rank for each possible non-tree link; and
selecting the possible non-tree links with the highest ranking.

3. The method of claim 2, wherein the calculating of the rank for each possible non-tree link between the semantic nodes uses similarity metric for corresponding entities according to their location in a semantic hierarchy.

4. The method of claim 1, wherein the at least two different syntactic nodes corresponding to a single entity belong to at least two different syntactic trees.

5. The method of claim 1, wherein the at least two different syntactic nodes include a controller node and a pronoun node controlled by the controller node;
wherein the determining that the controller node and the pronoun node correspond to a single entity includes accessing an anaphora rule for the pronoun node;
wherein the determining that the controller node and the pronoun node correspond to a single entity includes at least one of:
determining whether a syntactic tree path from the controller node to the pronoun node is among possible paths according to the rule;
determining whether at least one of properties of the controller node is possible according to the rule;
determining whether the controller node and the pronoun node are in grammatical agreement according to the rule;
determining whether the linear direction of a link between the controller node and the pronoun node is possible according to the rule;
determining whether a semantic node corresponding to the controller node and a semantic node corresponding to the pronoun node are semantically compatible;
determining whether a value of a non-tree link between the semantic node corresponding the controller node and the semantic node corresponding to the pronoun node is above a threshold value.

6. The method of claim 1, wherein the determining among the plurality of syntactic nodes the at least two different syntactic nodes corresponding to the single entity includes:
generating for the at least one syntactic tree different sets of non-tree links between at least some syntactic nodes of the plurality of syntactic nodes;
determining the rank of each set of non-tree links; and
determining that the syntactic nodes connected by the set of non-tree links with the highest rank correspond to a single entity.

7. A system for creating syntactic-semantic structures of natural language sentences in natural language processing of a natural language text, the system comprising:
a syntactic analysis module configured to generate at least one syntactic tree for each sentence including a plurality of syntactic nodes and a plurality of tree-like syntactic relations;
a semantic analysis module configured:
to generate at least one semantic structure corresponding to the at least one syntactic tree,
wherein the at least one semantic structure includes a plurality of semantic nodes corresponding to the plurality of syntactic nodes and a plurality of tree-like semantic relations corresponding to the plurality of tree-like syntactic relations;
to determine if the at least one syntactic tree includes at least two different syntactic nodes corresponding to a single entity, and then to connect the semantic nodes corresponding to the at least two different syntactic nodes by at least one non-tree link; and
a natural language processing module for further natural language processing of the text using the semantic structure.

8. The system of claim 7, wherein the connecting of the semantic nodes by the at least one non-tree link comprises:
generating a plurality of possible non-tree links between the syntactic nodes;
calculating a rank for each possible non-tree link; and
selecting the possible non-tree links with the highest ranking.

9. The system of claim 8, wherein the calculating a rank for each possible non-tree link uses similarity metric for entities in a semantic hierarchy corresponding to the semantic nodes corresponding to the syntactic nodes.

10. The system of claim 7, wherein the at least two different syntactic nodes belong to at least two different syntactic trees.

11. The system of claim 7, wherein the at least two different syntactic nodes include a controller node and a pronoun node controlled by the controller node;
wherein the determining that the controller node and the pronoun node correspond to a single entity includes accessing an anaphora rule for the pronoun node;
wherein the determining that the controller node and the pronoun node correspond to a single entity includes at least one of:
determining whether a syntactic tree path from the controller node to the pronoun node is among possible paths according to the rule;
determining whether at least one of properties of the controller node is possible according to the rule;
determining whether the controller node and the pronoun node are in grammatical agreement according to the rule;
determining whether the linear direction of a link between the controller node and the pronoun node is possible according to the rule;
determining whether a semantic node corresponding to the controller node and a semantic node corresponding to the pronoun node are semantically compatible;
determining whether a value of a non-tree link between the semantic node corresponding the controller node and the semantic node corresponding to the pronoun node is above a threshold value.

12. The system of claim 7, wherein the determining among the plurality of syntactic nodes the at least two different syntactic nodes corresponding to the single entity includes:
generating for the at least one syntactic tree different sets of non-tree links between at least some syntactic nodes of the plurality of syntactic nodes;
determining the rank of each set of non-tree links; and
determining that the syntactic nodes connected by the set of non-tree links with the highest rank correspond to a single entity.

13. A computer program product stored on a non-transitory computer-readable storage medium, the computer program product comprising computer-executable instructions for creating syntactic-semantic structures of natural language sentences in natural language processing of a natural language text, comprising instructions for:
generating by a hardware processor at least one syntactic tree for each sentence including a plurality of syntactic nodes and a plurality of tree-like syntactic relations;
generating by a hardware processor at least one semantic structure corresponding to the at least one syntactic tree,
wherein the at least one semantic structure includes a plurality of semantic nodes corresponding to the plurality of syntactic nodes and a plurality of tree-like semantic relations corresponding to the plurality of tree-like syntactic relations;
if the at least one syntactic tree includes at least two different syntactic nodes corresponding to a single entity, then connecting the semantic nodes corresponding to the at least two different syntactic nodes by at least one non-tree link; and
performing by the hardware processor further natural language processing of the text using the semantic structure.

14. The computer program product of claim 13, wherein the connecting of the semantic nodes by the at least one non-tree link comprises:
generating a plurality of possible non-tree links between the syntactic nodes;
calculating a rank for each possible non-tree link; and
selecting the possible non-tree links with the highest ranking.

15. The computer program product of claim 14, wherein the calculating a rank for each possible non-tree link uses similarity metric for entities in a semantic hierarchy corresponding to the semantic nodes corresponding to the syntactic nodes.

16. The computer program product of claim 13, wherein the at least two different syntactic nodes belong to at least two different syntactic trees.

17. The computer program product of claim 13, wherein the at least two different syntactic nodes include a controller node and a pronoun node controlled by the controller node;
wherein the determining that the controller node and the pronoun node correspond to a single entity includes accessing an anaphora rule for the pronoun node;
wherein the determining that the controller node and the pronoun node correspond to a single entity includes at least one of:
determining whether a syntactic tree path from the controller node to the pronoun node is among possible paths according to the rule;
determining whether at least one of properties of the controller node is possible according to the rule;
determining whether the controller node and the pronoun node are in grammatical agreement according to the rule;
determining whether the linear direction of a link between the controller node and the pronoun node is possible according to the rule;
determining whether a semantic node corresponding to the controller node and a semantic node corresponding to the pronoun node are semantically compatible;
determining whether a value of a non-tree link between the semantic node corresponding the controller node and the semantic node corresponding to the pronoun node is above a threshold value.

18. The computer program product of claim 13, wherein the determining among the plurality of syntactic nodes the at least two different syntactic nodes corresponding to the single entity includes:
generating for the at least one syntactic tree different sets of non-tree links between at least some syntactic nodes of the plurality of syntactic nodes;
determining the rank of each set of non-tree links; and
determining that the syntactic nodes connected by the set of non-tree links with the highest rank correspond to a single entity.
